(19) United States
(12) Patent Application Publication
(10) Pub. No.: US 2009/0261757 A1
(43) Pub. Date: Oct. 22, 2009

(54) Backlight driving circuit and driving method thereof

(75) Inventors: Chia-Yuan Wu, Miao-Li (TW); Yen-Hua Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/386,618

(22) Filed: Apr. 20, 2009

(30) Foreign Application Priority Data
Apr. 18, 2008 (CN) 200810066832.8

(51) Int. Cl. H05B 37/02

(52) U.S. Cl. 315/307

(57) ABSTRACT

A backlight driving circuit includes a driving unit, a light source, a power supply circuit, and a controller connected to the driving unit. The power supply circuit includes a low voltage output terminal for outputting a low DC voltage and a high voltage output terminal for outputting a high DC voltage. If the backlight driving circuit is in a normal operation mode, the driving unit transforms the high DC voltage to a constant current for driving the light source by control of the controller. If the backlight driving circuit is in a power saving operation mode, the low DC voltage drives the light source by control of the controller.

### BACKGROUND

1. Technical Field

The present invention relates to a backlight driving circuit typically used for a liquid crystal display (LCD), and a driving method of the backlight driving circuit.

2. Description of Related Art

A typical LCD provides portability and low power consumption, yet with low radiation, and finds wide use in various portable information devices such as notebooks, personal digital assistants (PDAs), video cameras and others. A typical LCD includes an LCD panel, one or more backlights for illuminating the LCD panel, and a backlight driving circuit for driving the backlights.

FIG. 6 shows a circuit diagram of a common backlight driving circuit. The backlight driving circuit 1 includes a power supply circuit 11, a constant current circuit 12, a controller 13, and a light source 14. The power supply circuit 11 includes a low voltage output terminal 111 and a high voltage output terminal 112. The low voltage output terminal 111 is configured for providing an operating voltage to other circuits (not shown) in an LCD panel. The high voltage output terminal 112 is configured for driving the light source 14. The low voltage output terminal 111 outputs a low direct current (DC) voltage, such as 2.8V, 3V, 3.1V, 3.2V and so on. The high voltage output terminal 112 outputs a high DC voltage to the constant current circuit 12.

The controller 13 is configured for generating pulse signals according to an operation mode of the backlight driving circuit 1. The operation mode of the backlight driving circuit 1 includes a power saving operation mode and a normal operation mode. A duty ratio of the pulse signals in the normal operation mode is greater than that of the pulse signals in the power saving operation mode. The constant current circuit 12 receives the pulse signals and the high DC voltage, and transforms the high DC voltage to a constant current supplied to the light source 14 according to the duty ratio of the pulse signals. The constant current drives the light source 14. The light source 14 can be a light emitting diode (LED).

Usually, the transfer efficiency of electric energy of the constant current circuit 12 is lower than 85 percent. Whether the backlight driving circuit 1 is in the normal operation mode or the power saving mode, the constant current for driving the light source 14 is output from the constant current circuit 12. Therefore, an efficiency of the backlight driving circuit is relatively low even when the backlight driving circuit 1 is in the power saving mode.

What is needed, therefore, are a backlight driving circuit and a driving method which can overcome the described limitations.

### BRIEF DESCRIPTION OF THE DRAWINGS

FIG. 1 is a circuit diagram of a backlight driving circuit according to a first embodiment of the present invention.

FIG. 2 is a flow chart of an exemplary driving method of the backlight driving circuit of FIG. 1.

FIG. 3 is a circuit diagram of a backlight driving circuit according to a second embodiment of the present invention.

FIG. 4 is a circuit diagram of a backlight driving circuit according to a third embodiment of the present invention.

FIG. 5 is a circuit diagram of a backlight driving circuit according to a fourth embodiment of the present invention.

FIG. 6 is a circuit diagram of a common backlight driving circuit.

### DETAILED DESCRIPTION

Reference will now be made to the drawings to describe preferred and exemplary embodiments of the invention in detail.

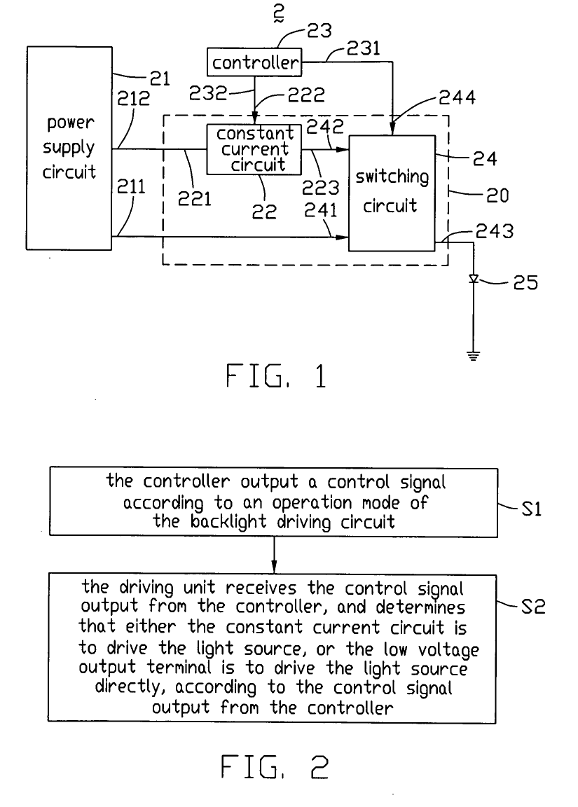

FIG. 1 is a circuit diagram of a backlight driving circuit according to a first embodiment of the present invention. The backlight driving circuit 2 includes a power supply circuit 21, a driving unit 20, a controller 23, and a light source 25. The driving unit 20 includes a constant current circuit 22 and a switching circuit 24. The light source 25 can be an LED.

The power supply circuit 21 includes a low voltage output terminal 211 and a high voltage output terminal 212. The low voltage output terminal 211 is configured for providing an operating voltage to other circuits (not shown) in an LCD panel and to the switching circuit 24. The high voltage output terminal 212 is configured for driving the light source 25. The low voltage output terminal 211 outputs a low DC voltage, such as 2.8V, 3V, 3.1V, 3.2V and so on. The high voltage output terminal 212 outputs a high DC voltage to the constant current circuit 22.

The switching circuit 24 includes a first input terminal 241, a second input terminal 242, a control terminal 244, and an output terminal 243. The output terminal 243 is grounded via the light source 25. The first input terminal 241 is connected to the low voltage output terminal 211 of the power supply circuit 21.

The constant current circuit 22 includes a voltage input terminal 221, a constant current output terminal 223, and a pulse signal input terminal 222. The voltage input terminal 221 is connected to the high voltage output terminal 212 of the power supply circuit 21. The constant current output terminal 223 is connected to the second input terminal 242 of the switching circuit 24.

The controller 23 includes a control signal output terminal 231 and a pulse signal output terminal 232. The control signal output terminal 231 is connected to the control terminal 244 of the switching circuit 24. The pulse signal output terminal 232 is connected to the pulse signal input terminal 222 of the constant current circuit 22.

FIG. 2 is a flow chart of an exemplary driving method of the backlight driving circuit 2. The driving method of the backlight driving circuit 2 is described as below.

In Step S1, the controller 23 output a control signal according to an operation mode of the backlight driving circuit 2. If the backlight driving circuit 2 is in a normal operation mode, the controller 23 outputs a first control signal via the control signal output terminal 231 and a pulse signal via the pulse signal output terminal 232. If the backlight driving circuit 2 is in a power saving operation mode, the controller 23 outputs a second control signal via the control signal output terminal 231.

In Step S2, the driving unit 20 receives the control signal output from the controller 23. The driving unit 20 determines that either the constant current circuit 22 is to drive the light source 25, or the low voltage output terminal 211 is to drive the light source 25 directly, according to the control signal output from the controller 23. When the backlight driving circuit 2 is in the normal operation mode, the output terminal 243 of the switching circuit 24 is connected to the second input terminal 242 by control of the first control signal. The frequency of the pulse signal can be greater than 15 kilohertz (kHz). The constant current circuit 22 receives the pulse signal output from the controller 23 and the high DC voltage generated by the power supply circuit 21, and transforms the high DC voltage to a constant current for driving the light source 25. When the backlight driving circuit 2 is in the power saving operation mode, the output terminal 243 of the switching circuit 24 is connected to the first input terminal 241. Therefore, the light source 25 is directly driven by the low DC voltage generated by the power supply circuit 21.

Because the backlight driving circuit 2 further includes the switching circuit 24, when the backlight driving circuit 2 is in the power saving operation mode, the power supply circuit 21 can drive the light source 25 directly by control of the switching circuit 24. Thus, the constant current circuit 22 has no load. Therefore, any loss of electric energy inherent in operation of the constant current circuit 22 is circumvented. Accordingly, the efficiency of the backlight driving circuit 2 is comparatively high.

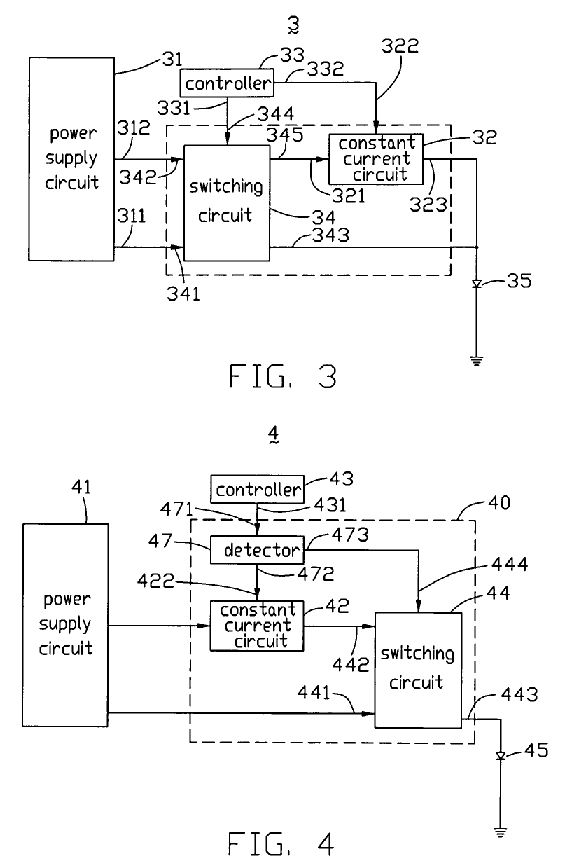

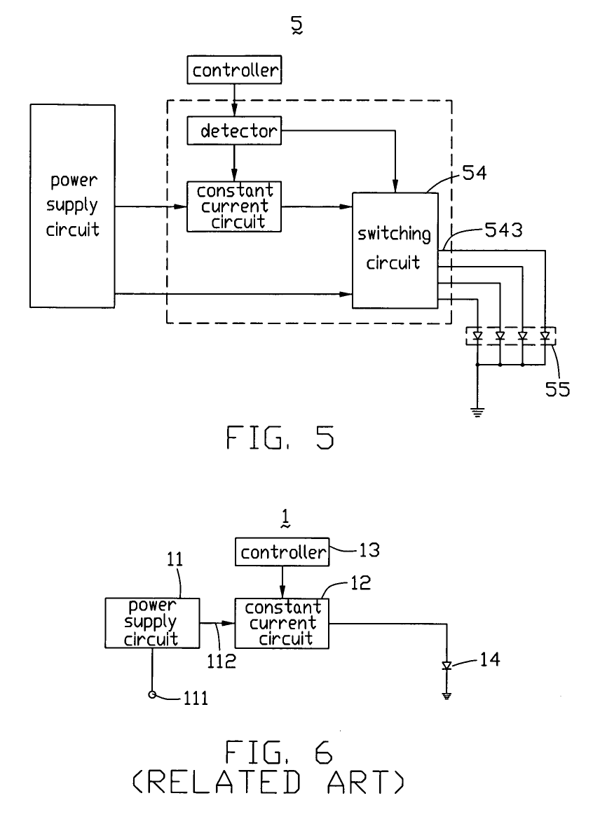

FIG. 3 is a circuit diagram of a backlight driving circuit according to a second embodiment of the present invention. The backlight driving circuit 3 is similar to the backlight driving circuit 2, except that a switching circuit 34 includes first and second output terminals 343, 345, and a connection relationship between the switching circuit 34 and a constant current circuit 32 is different. A first input terminal 341 of the switching circuit 34 is connected to a low voltage output terminal 311 of a power supply circuit 31. A second input terminal 342 of the switching circuit 34 is connected to a high voltage output terminal 312 of the power supply circuit 31. A control terminal 344 of the switching circuit 34 is connected to a control signal output terminal 331 of a controller 33. The first output terminal 343 of the switching circuit 34 is grounded via a light source 35. The second output terminal 345 of the switching circuit 34 is connected to a voltage input terminal 321 of the constant current circuit 32. A pulse signal input terminal 322 of the constant current circuit 32 is connected to a pulse signal output terminal 332 of the controller 33. A constant current output terminal 323 is grounded via the light source 35.

An exemplary driving method of the backlight driving circuit 3 is described as follows. When the backlight driving circuit 3 is in a normal operation mode, the controller 33 outputs a first control signal via the control signal output terminal 331 and a pulse signal via the pulse signal output terminal 332. The second output terminal 345 of the switching circuit 34 is connected to the second input terminal 342 by control of the first control signal. At the same time, the first output terminal 343 of the switching circuit 34 is disconnected from the first input terminal 341 by control of the first control signal. The constant current circuit 32 receives the pulse signal and a high DC voltage from the high voltage output terminal 342, and transforms the high DC voltage to a constant current for driving the light source 35. When the backlight driving circuit 3 in a power saving operation mode, the controller 33 outputs a second control signal via the control signal output terminal 331. The first output terminal 343 of the switching circuit 34 is connected to the first input terminal 341 by control of the second control signal. The second output terminal 345 is disconnected from the second input terminal 342 by control of the second control signal. Therefore, the light source 35 is directly driven by a low DC voltage generated by the power supply circuit 31.

When the backlight driving circuit 3 is in the power saving operation mode, the constant current circuit 32 is disconnected from the power supply circuit 31. Thus, the constant current circuit 32 is not working during such time. Therefore, any loss of electric energy inherent in operation of the constant current circuit 32 is circumvented. Accordingly, the efficiency of the backlight driving circuit 3 is comparatively high.

FIG. 4 is a circuit diagram of a backlight driving circuit according to a third embodiment of the present invention. The backlight driving circuit 4 is similar to the backlight driving circuit 2, except that a driving unit 40 further includes a detector 47, and a controller 43 only includes one output terminal 431 for outputting a pulse signal. The detector 47 is configured to detect a duty ratio of the pulse signal, determine an operation mode of the backlight driving circuit 4 according to the duty ratio, and output a control signal according to the operation mode of the backlight driving circuit 4. A duty ratio of the pulse signal in a normal operation mode is greater than a duty ratio of the pulse signal in a power saving operation mode. The detector 47 includes a signal input terminal 471 connected to the output terminal 431, a control signal output terminal 473 connected to a control terminal 444 of a switching circuit 44, and a pulse signal output terminal 472 connected to a pulse signal input terminal 422 of a constant current circuit 42.

An exemplary driving method of the backlight driving circuit 4 includes the following steps. When the controller 43 outputs a pulse signal with a higher duty ratio, the detector 47 receives the pulse signal and determines that the backlight driving circuit 4 is in the normal operation mode. Thus, the detector 47 outputs a first control signal and the pulse signal according to the normal operation mode. An output terminal 443 of the switching circuit 44 is connected to a second input terminal 442 of the switching circuit 44 by control of the first control signal. The constant current circuit 42 receives the pulse signal and a high DC voltage from a power supply circuit 41, and transforms the high DC voltage to a constant current for driving a light source 45. When the controller 43 outputs a pulse signal with a lower duty ratio, the detector 47 receives the pulse signal and determines that the backlight driving circuit 4 is in the power saving operation mode. Thus, the detector 47 outputs a second control signal according to the lower duty ratio. The output terminal 443 of the switching circuit 44 is connected to a first input terminal 441 of the switching circuit 44 by control of the second control signal. Therefore, the light source 45 is directly driven by a low DC voltage generated by the power supply circuit 41.

FIG. 5 is a circuit diagram of a backlight driving circuit according to a fourth embodiment of the present invention. The backlight driving circuit 5 is similar to the backlight driving circuit 4, except that a switching circuit 54 includes a plurality of output terminals 543, and a light source 55 includes a plurality of LEDs. Each output terminal 543 is grounded via a respective LED.

It is to be further understood that even though numerous characteristics and advantages of preferred and exemplary embodiments have been set out in the foregoing description, together with details of structures and functions associated with the embodiments, the invention is illustrative only; and that changes may be made in detail (including in matters of arrangement of parts) within the principles of the invention to the full extent indicated by the broad general meaning of the terms in which the appended claims are expressed.

What is claimed is:

1. A backlight driving circuit, comprising:
a driving unit;
a light source;
a power supply circuit comprising:
a low voltage output terminal for outputting a low direct current (DC) voltage; and
a high voltage output terminal for outputting a high DC voltage; and
a controller connected to the driving unit;
wherein, if the backlight driving circuit is in a normal operation mode, the driving unit transforms the high DC voltage to a constant current for driving the light source by control of the controller; and if the backlight driving circuit is in a power saving operation mode, the low DC voltage drives the light source by control of the controller.

2. The backlight driving circuit of claim 1, wherein the driving unit comprises a constant current circuit and a switching circuit, the controller comprising a control signal output terminal and a pulse signal output terminal, the constant current circuit comprising a voltage input terminal connected to the high voltage output terminal of the power supply circuit, a constant current output terminal, and a pulse signal input terminal connected to the pulse signal output terminal of the controller, and the switching circuit comprising a first input terminal connected to the low voltage output terminal of the power supply circuit, a second input terminal connected to the constant current output terminal of the constant current circuit, and a control terminal connected to the control signal output terminal of the controller, and an output terminal connected to the light source.

3. The backlight driving circuit of claim 2, wherein if the backlight driving circuit is in the normal operation mode, the output terminal of the switching circuit is connected to the second input terminal; and if the backlight driving circuit is in the power saving operation mode, the output terminal of the switching circuit is connected to the first input terminal.

4. The backlight driving circuit of claim 3, wherein a frequency of the pulse signal output from the controller is greater than 15 kilohertz.

5. The backlight driving circuit of claim 1, wherein the driving unit comprises a constant current circuit and a switching circuit, the controller comprising a control signal output terminal and a pulse signal output terminal, the constant current circuit comprising a voltage input terminal, a constant current output terminal connected to the light source, and a pulse signal input terminal connected to the pulse signal output terminal of the controller, and the switching circuit comprising a first input terminal connected to the low voltage output terminal of the power supply circuit, a second input terminal connected to the high voltage output terminal of the power supply circuit, a control terminal connected to the control signal output terminal of the controller, a first output terminal connected to the light source, and a second output terminal connected to the voltage input terminal of the constant current circuit.

6. The backlight driving circuit of claim 5, wherein if the backlight driving circuit is in the normal operation mode, the second output terminal of the switching circuit is connected to the second input terminal; and if the backlight driving circuit is in the power saving operation mode, the first output terminal of the switching circuit is connected to the first input terminal.

7. The backlight driving circuit of claim 6, wherein a frequency of the pulse signal output from the controller is greater than 15 kilohertz.

8. The backlight driving circuit of claim 1, wherein the driving unit comprises a detector, the controller comprising an output terminal for outputting a pulse signal, the detector configured for detecting a duty ratio of the pulse signal, and determining an operation mode of the backlight driving circuit according to the duty ratio.

9. The backlight driving circuit of claim 8, wherein a duty ratio of the pulse signal in the normal operation mode is greater than that of the pulse signal in the power saving operation mode.

10. The backlight driving circuit of claim 8, wherein the driving unit comprises a constant current circuit and a switching circuit, the detector comprising a signal input terminal connected to the output terminal of the controller, a pulse signal output terminal, and a control signal output terminal, the constant current circuit comprising a voltage input terminal connected to the high voltage output terminal of the power supply circuit, a constant current output terminal, and a pulse signal input terminal connected to the pulse signal output terminal of the detector, and the switching circuit comprising a first input terminal connected to the low voltage output terminal of the power supply circuit, a second input terminal connected to the constant current output terminal of the constant current circuit, a control terminal connected to the control signal output terminal of the detector, and an output terminal connected to the light source.

11. The backlight driving circuit of claim 10, wherein if the backlight driving circuit is in the normal operation mode, the output terminal of the switching circuit is connected to the second input terminal; and if the backlight driving circuit is in the power saving operation mode, the output terminal of the switching circuit is connected to the first input terminal.

12. The backlight driving circuit of claim 11, wherein a frequency of the pulse signal output from the controller is greater than 15 kilohertz.

13. The backlight driving circuit of claim 12, wherein the switching circuit further comprises at least another output terminal, the light source comprises a plurality of light emitting diodes (LEDs), and each of the output terminals is capable of being grounded via a respective LED.

14. The backlight driving circuit of claim 1, wherein the low DC voltage is one of approximately 2.8V, approximately 3V, approximately 3.1V, and approximately 3.2V.

15. A driving method of a backlight driving circuit, wherein the backlight driving circuit comprises a driving unit, a light source, a power supply circuit, and a controller, the power supply circuit comprising a low voltage output terminal for outputting a low direct current (DC) voltage and a high voltage output terminal for outputting a high DC voltage, the method comprising:
a. the controller outputting a control signal according to an operation mode of the backlight driving circuit; and
b. the driving unit receiving the control signal output from the controller, and determining that either the driving unit is to transform the high DC voltage to a constant current to drive the light source or the low voltage output terminal is to drive the light source, according to the control signal output from the controller.

16. The driving method of claim 15, wherein in “a”, when the backlight driving circuit is in a normal operation mode, the controller outputs a first control signal and a pulse signal to the driving unit; and when the backlight driving circuit is in a power saving operation mode, the controller outputs a second control signal to the driving unit.

17. The driving method of claim 16, wherein the driving unit comprises a constant current circuit and a switching circuit; and in “a.”, when the backlight driving circuit is in the normal operation mode, the controller outputs a first control signal to the switching circuit and a pulse signal to the constant current circuit; and when the backlight driving circuit is in the power saving operation mode, the controller outputs a second control signal to the switching circuit.

18. The driving method of claim 17, wherein in “b.”, the constant current circuit transforms the high DC voltage to a constant current for driving the light source by control of the first control signal and the pulse signal; and the low voltage output terminal drives the light source by control of the second control signal.

19. A driving method of a backlight driving circuit, wherein the backlight driving circuit comprises a driving unit, a light source, a power supply circuit, a detector, and a controller, the power supply circuit comprising a low voltage output terminal for outputting a low direct current (DC) voltage and a high voltage output terminal for outputting a high DC voltage, the method comprising:
a. the controller outputting a pulse signal;
b. the detector receiving the pulse signal, determining an operation mode of the backlight driving circuit according to the pulse signal, and outputting a control signal according to the operation mode of the backlight driving circuit; and
c. the driving unit receiving the control signal output from the detector, and determining that either the driving unit is to transform the high DC voltage to a constant current to drive the light source or the low voltage output terminal is to drive the light source, according to the control signal output from the detector.

20. The driving method of claim 19, wherein in “b.”, if the pulse signal has a high duty ratio, the detector determines that the backlight driving circuit is in a normal operation mode; and if the pulse signal has a low duty ratio, the detector determines that the backlight driving circuit is in a power saving operation mode.
